(19) United States
(12) Patent Application Publication
(10) Pub. No.: US 2010/0066743 A1
(43) Pub. Date: Mar. 18, 2010

(54) Method for improved visualization of dynamic values displayed in a digital format

(76) Inventor: Gustavo Adolfo Fortmann, Peoria, IL (US)

Correspondence Address: WENDEROTH, LIND & PONACK, L.L.P., 1030 15th Street, N.W.,, Suite 400 East, Washington, DC, 20005-1503, US

(21) Appl. No.: 12/232,430

(22) Filed: Sep. 17, 2008

(51) Int. Cl. G09G 5/22

(52) U.S. Cl. 345/440.1

(57) ABSTRACT

A method is provided for improved visualization of digitally displayed values that change rapidly, based on the human ability to perceive only a certain amount of change within a specific time-frame. The changes to the value are displayed so that, whenever possible, only one digit changes within the time-frame thought to be ideal for a user to perceive the change of a single digit. The actual value displayed will follow the true value as closely as possible, hence, in most cases, only the digit that moves the displayed value closest to the true value will trigger a change during a perception time frame. If the true value stops changing, the displayed value will, by this fashion, completely catch up with the true value in a prompt manner and exactly match it. If the true value oscillates rapidly, the oscillation will only be displayed to the extent that it allows the viewer to perceive the changes. Only the amount of change that can be perceived is actually shown, thus greatly improving the readability of digital displays.

### BACKGROUND OF THE INVENTION

Variables with values that vary rapidly, such as the rotation speed of a vehicle's engine, are most often displayed in an analog fashion so that a viewer can easily perceive a change in the value. When such a dynamic value is displayed in a digital manner, and if the value is not processed in any way, the result is a display which is either unreadable or one which requires too much concentration on the part of the viewer to achieve perception of the value displayed.

Conventional techniques have attempted to solve this problem for the display of engine RPM values in a vehicle's panel. For the specific case of an engine's RPM, it is clear that the driver of the vehicle must be able to view (or perceive) the current RPM value at a glance, without having to look at the display for much longer than what could be dangerous. Also, the value must be displayed in a manner that it is not annoying to the driver, and in a manner that does not affect the driver's mood in a detrimental way.

The main conventional approach to provide a readable digital display involves slowing down the rate of change of the value that is displayed, which utilizes the same principle as the well known sample and hold technique in electronics, and will therefore be referred to herein as a “sample and hold” technique for ease of explanation purposes. In this technique, a first sampling of an input value is taken (e.g., any value, preprocessed or not, for which visualization is desired), and the input value is displayed on the digital display (e.g., an LCD display unit). This input value is maintained as the value shown on the digital display until the next sampling of an input value is carried out, with each sampling after the first sampling taking place at a fixed predetermined amount of time after the previous sampling. When each sampling takes place, the input value displayed on the digital display is updated to reflect the new input value at the current sampling, with the sampling time purposely made longer than what is technically possible, in order to obtained a slowed-down update rate, as previously mentioned.

In FIG. 10, exemplary values associated with such a sample and hold technique are shown in a table. As shown in FIG. 10, in this example, the sampling takes place every 600 ms, whereby a new input value is displayed at each sampling. As shown in FIG. 10, because the displayed values are the same as the actual input values, multiple digits can change at each sampling instance and it can be very difficult for a viewer to comfortably perceive such a significant change in the displayed value during the short time the number is displayed. However, if the sampling period is increased in order to provide more time to view the value, then the value displayed significantly lags behind the true input value, and therefore, will not provide an accurate representation of the true instantaneous input-value.

Due to the above-described problems with the conventional approach, it is still customary, even in the current digital age, to use analog tachometers over potentially more convenient digital meters.

### SUMMARY OF THE INVENTION

The objective of the present invention is to provide a method for displaying the value of a numerical variable in a digital manner stressing maximized readability and precision even if the numerical value changes rapidly.

The principle behind the present invention is that a human being can more easily detect a single change than multiple changes, and that in fact, when multiple changes occur simultaneously they interfere with each other and make the time required to recognize the collective changes longer than the sum of the time required to view each individual change should they occur one at a time.

When displaying a number in a digital manner, the “changes” can be described as every digit in a particular position that is different from the digit of the previously displayed value in that same position. Analog meters, by nature, experience only one change at a time, namely, the needle position, although looking at the needle alone offers only a rough estimate of the rate of change and of the variable's (RPM) current value. It is necessary to read the scale value pointed by the needle in order to get an exact reading of the variable, which becomes particularly difficult when the needle moves quickly.

The present invention emulates the behavior of an analog meter by limiting the number of changes to one at a time whenever possible so as to increase the readability of the display.

The present invention differs from the conventional sample and hold approach in that ease of viewing, or readability, is accomplished in the conventional approach by providing more time for the viewer to perceive all the changes in an updating value (i.e., by increasing the sampling time), whereas the present invention seeks to increase the readability of a display by mainly limiting the changes in successive values to a minimum so that, whenever possible, only one digit changes within the time-frame thought to be ideal for a viewer to perceive change in a single digit position. The value displayed should follow the true value as closely as possible, hence only the digit that moves the displayed value closest to the true value will trigger a change during a perception time frame. If the true value stops changing, the displayed value will, by this fashion, completely catch up with the true value in a prompt manner and exactly match it.

The present invention can also be tuned to display the most important changes faster than the less important ones; hence the update rate of the display in the present invention is not at the conventional fixed-interval approach and can take place at irregular intervals of time, dependent upon the digit that triggers an update. The invention can also be applied to any number of digits, positive or negative values, and to values with or without decimal points.

### BRIEF DESCRIPTION OF THE DRAWINGS

Aspects of the present invention will become more apparent by describing in detail embodiments thereof with reference to the attached drawings in which:

FIG. 1 is a flow chart showing a digital display method according to a first illustrative embodiment of the present invention;

FIG. 2 is a table showing digital display values according to the first embodiment of the present invention when utilizing the same minimum update delay for each digit position;

FIG. 3 is a graph showing a comparison between the percentile error for the digital display method according to the first embodiment when utilizing the same minimum update delay for each digit position and the percentile error for the conventional sample and hold digital display method, when both methods are compared to the input value;

FIG. 4 is a table showing digital display values according to the first embodiment of the present invention using tuned minimum update delays for all digit positions;

FIG. 5 is a graph showing a comparison between the percentile error for the digital display method according to the first embodiment when utilizing tuned minimum update delays for all digit positions and the percentile error for the conventional sample and hold digital display method, when both methods are compared to the input value;

FIG. 6 is a graph showing a comparison between digital display values using the same minimum update delay for each digit position, a tuned minimum update for each digit position, and the conventional sample and hold technique;

FIG. 7 is a flow chart showing a digital display method according to a second illustrative embodiment of the present invention;

FIG. 8 is a graph showing a comparison between digital display values when using constant thresholds or a single fixed threshold, and variable thresholds;

FIG. 9 is a flow chart showing a digital display method according to a third illustrative embodiment of the present invention; and

FIG. 10 is a table showing digital display values according to a conventional sample and hold method.

### DETAILED DESCRIPTION OF THE INVENTION

The following description of the invention discloses specific configurations, features, and operations. However, the description is merely of an example of the present invention, and thus, the specific features described below are merely used to more easily describe the invention and to provide an overall understanding of the present invention.

Accordingly, one skilled in the art will readily recognize that the present invention is not limited to the specific embodiments described below. Furthermore, the description of various configurations, features, and operations of the present invention that are known to one skilled in the art are omitted for the sake of clarity and brevity. Also, it is to be understood that the phraseology and terminology employed herein is for the purpose of description and should not be regarded as limiting.

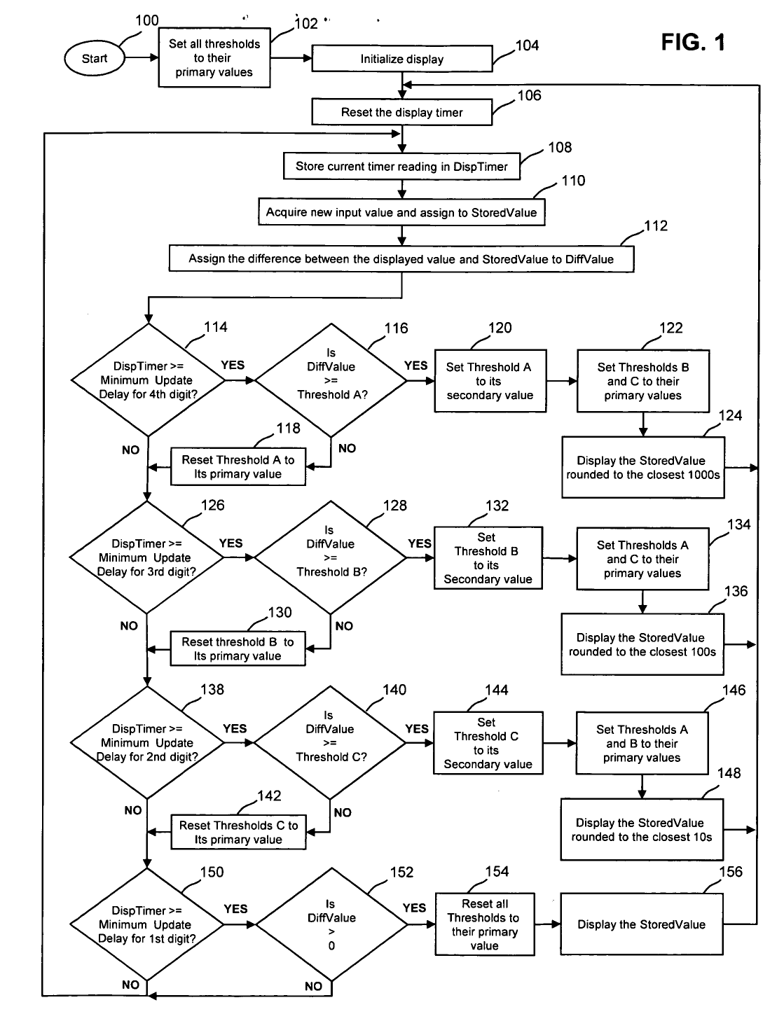

FIG. 1 is a flow chart explaining an illustrative embodiment of the present invention for positive integer numbers with a numerical value having a maximum of 4 digits, the digit positions being numbered from the lowest order of magnitude to the highest as digit position 1 for the 1s, digit position 2 for the 10s, digit position 3 for the 100s, and digit position 4 for the 1000s. Any digit position of possible digits of the numerical value may be considered as a test digit position, with the digit positions being referred to herein simply as “digit” for ease of explanation purposes.

The method described herein can be applied to the display of any value regardless of the number of digits the value may have, independent of the sign of the value and is not limited by whether the value has a decimal point or not. The implementation shown in FIG. 1 is just one example of the present invention, and those of ordinary skill in the art will recognize that this is not the only way to implement the present invention.

According to the flow chart shown in FIG. 1, in step 102, all thresholds (i.e., Thresholds A, B and C) are set to their primary values. It is noted that each threshold is a threshold of magnitude (i.e., a magnitude threshold value), but will be referred to herein simply as “threshold” for ease of explanation purposes. In a typical application, the primary threshold for Threshold A is set as 1000, the primary threshold for Threshold B is set as 100, and the primary threshold for Threshold C is set as 10. After setting the thresholds to their primary values, the display is initialized in step 104, which can be done by acquiring an input value, which can be a raw value (e.g., the direct reading of an RPM value) or a modified raw value (e.g., an RPM value that has been pre-processed by pre-filtering or any other method), and displaying the input value on the digital display (e.g., an LCD display unit).

In step 106 of FIG. 1, a display timer is reset to zero and started. After the display timer is reset and started, an update loop begins with step 108, in which a current reading of the display timer is stored, this current reading being called herein DispTimer. Next, in step 110, a new input value is acquired and this value is assigned as a stored value, called herein StoredValue.

After assigning the input value to the StoredValue, in step 112, the absolute difference (i.e., the positive value of the difference) between the value currently being displayed and the StoredValue is assigned as a difference value, called herein DiffValue. Next, a determination is made in step 114 as to whether the value stored as DispTimer (i.e., the display timer reading obtained in step 108) is greater than or equal to a predetermined minimum update delay that has been set for the fourth digit (i.e., the 1000s digit).

The predetermined minimum update delay set for the fourth digit is the period of time since the digital display was last updated before the threshold set for the fourth digit can trigger a new screen update (i.e., displaying a new value thereon), the predetermined minimum update delay being set to a period of time which is long enough for a viewer of the digital display to be able to read a single digit change in the value shown on the display, while short enough to follow the input value as closely as possible.

In the present embodiment described herein, each digit is provided with an independent minimum update delay which can be tuned (i.e., customized), and thus, the actual rate of screen update may depend on the rate of change of the input value. By controlling the digits such that each digit has an independent minimum update delay (i.e., the minimum amount of time since the last display screen update before the threshold assigned to that digit can trigger a new screen update), the display screen may be updated at irregular and non-predictable intervals rather than at fixed predetermined intervals as is customary in traditional approaches.

For example, as the magnitude of the digits decreases (e.g., from the 100s digit to the 10s digit), the importance of a change in their value often decreases. Accordingly, by providing a larger minimum update delay for each lower magnitude digit, or in other words, by setting the minimum update delay for each digit position to be slightly longer than the minimum update delay of the digit one order of magnitude greater, it is possible to provide a display with a small number of changes per display update.

As indicated above, the specific minimum update delay set for each digit can be tuned (i.e., customized) by a user, wherein the customization may be based on such factors as the type of application that the digital display is being used in connection with, as well as the typical viewer that will be viewing the display.

Also, it should be noted that the present invention could be implemented by providing each digit with the same predetermined minimum update delay. For example, rather than providing each digit with a tuned minimum update delay as described above, which may be different for each digit, the present embodiment may also be implemented such that the minimum update delay for each digit is the same.

Turning back to FIG. 1, if it is determined in step 114 that DispTimer is not greater than or equal to the minimum update delay for the fourth digit, then the routine proceeds to step 126, where it is determined if DispTimer is greater than or equal to the minimum update delay for the third digit. As is evident from FIG. 1, if the determination in step 126 is “No”, the routine proceeds to step 138, and if the determination in step 138 is also “No”, then the routine proceeds to step 150, with a determination of “No” therein causing the routine to proceed back to step 108 in which the current timer reading is newly stored as DispTimer.

On the other hand, if it is determined in step 114 that the DispTimer is greater than or equal to the minimum update delay for the fourth digit, then the routine proceeds to step 116, in which a determination is made as to whether the DiffValue (i.e., the absolute difference between the currently displayed value and the StoredValue) is greater than or equal to the Threshold A, with the Threshold A being the threshold value associated with the fourth digit.

In the present embodiment, Threshold A is preset by a user to have both a primary value and a secondary value, with the primary value being a value such as 1000, and the secondary value being a value less than the primary value, such as 500. It is noted that these are just examples of the values that can be used as the primary and secondary thresholds for Threshold A. Such primary and secondary thresholds could be any other values set by the user which may be customized based on factors such as the type of application that the digital display is being used in connection with and/or the operating conditions. The primary and secondary thresholds for Threshold A may also be set to the same value.

In step 116, if the determination is “Yes” (i.e., that the DiffValue is greater than or equal to Threshold A), then Threshold A is set to its secondary value in step 120, Thresholds B and C are set to their primary values in step 122 (or remain at their primary values if currently holding their primary values), and the digital display screen is updated in step 124 by replacing the previously displayed value with the StoredValue rounded to the closest 1000s digit. It is noted that the advantage of reducing the threshold value to the secondary threshold (e.g., in steps 120, 132 and 144) once the primary threshold value has been met (e.g., in steps 116, 128 and 140) is that the value shown on the display will update more “in-tune” with (i.e., follow more closely) the changing input value.

After displaying the updated numerical value on the display screen, the routine proceeds to perform the steps described above, namely, reset the display timer (step 106), store the current timer reading in DispTimer (step 108), acquire a new input value and assign to StoredValue (step 110), assign the absolute difference between the currently displayed value and the StoredValue to DiffValue (step 112), and determine whether the DispTimer is greater than or equal to the minimum update delay for the fourth digit (step 114). Assuming that the determination in step 114 is once again “Yes”, if it is then determined in step 116 that the DiffValue is not greater than or equal to Threshold A (which is currently set at its secondary value), then the Threshold A is reset to its primary value in step 118, and the routine proceeds to evaluate the conditions for a digit having a lower order of magnitude.

In particular, in step 126, a determination is made as to whether the DispTimer is greater than or equal to the minimum update delay for the third digit (i.e., 100s digit). A similar routine is then carried out for the third digit as was described above with reference to the fourth digit.

Namely, if it is determined in step 126 that DispTimer is not greater than or equal to the minimum update delay for the third digit, then the routine proceeds to step 138, where it is determined if DispTimer is greater than or equal to the minimum update delay for the second digit. On the other hand, if the determination in step 126 is “Yes”, then it is determined in step 128 whether the DiffValue is greater than or equal to Threshold B.

In the present embodiment, Threshold B is preset by a user to have both a primary value and a secondary value, with the primary value being a value such as 100, and the secondary value being a value less than the primary value, such as 50. It is noted that these are just examples of the values that can be used as the primary and secondary thresholds for Threshold B, and could be any other values set by the user which may be customized based on factors such as the type of application that the digital display is being used in connection with and/or the operating conditions. The primary and secondary thresholds for Threshold B may also be set to the same value.

In step 128, if the determination is “Yes”, then Threshold B is set to its secondary value in step 132, Thresholds A and C are set to their primary values in step 134, and the digital display screen is updated in step 136 by replacing the previously displayed value with the StoredValue rounded to the closest 100s digit.

After displaying the updated value on the display screen, the routine proceeds to perform steps described above, namely, reset the display timer (step 106), store the current timer reading in DispTimer (step 108), acquire a new input value and assign to StoredValue (step 110), assign the absolute difference between the currently displayed value and the StoredValue to DiffValue (step 112), and determine whether the DispTimer is greater than or equal to the minimum update delay for the fourth digit (step 114). Assuming that the determination in step 114 is “No” and that the determination in step 126 is “Yes”, if it is then determined in step 128 that the DiffValue is not greater than or equal to Threshold B (which is currently set at its secondary value), then the Threshold B is reset to its primary value in step 130, and the routine proceeds to evaluate the conditions for a digit having a lower order of magnitude.

In particular, in step 138, a determination is made as to whether the DispTimer is greater than or equal to the minimum update delay for the second digit (i.e., 10s digit). A similar routine is carried out for the second digit as described above with reference to the third and fourth digits.

Namely, if the determination in step 138 is that DispTimer is not greater than or equal to the minimum update delay for the second digit, then the routine proceeds to step 150, where it is determined if DispTimer is greater than or equal to the minimum update delay for the first digit. On the other hand, if the determination in step 138 is “Yes”, then it is determined in step 140 whether the DiffValue is greater than or equal to Threshold C.

In the present embodiment, Threshold C is preset by a user to have both a primary value and a secondary value, with the primary value being a value such as 10, and the secondary value being a value less than the primary value, such as 5. Such primary and secondary thresholds could be any other values set by the user which may be customized based on factors such as the type of application that the digital display is being used in connection with and/or the operating conditions. The primary and secondary thresholds for Threshold C may also be set to the same value.

In step 140, if the determination is “Yes”, then Threshold C is set to its secondary value in step 144, Thresholds A and B are set to their primary values in step 146, and the digital display screen is updated in step 148 by replacing the previously displayed value with the StoredValue rounded to the closest 10s digit.

After displaying the updated value on the display screen, the routine proceeds to perform steps described above, namely, reset the display timer (step 106), store the current timer reading in DispTimer (step 108), acquire a new input value and assign to StoredValue (step 110), assign the absolute difference between the currently displayed value and the StoredValue to DiffValue (step 112), and determine whether the DispTimer is greater than or equal to the minimum update delay for the fourth digit (step 114). Assuming that the determination in steps 114 and 126 are “No”, and that the determination in step 138 is “Yes”, if it is then determined in step 140 that the DiffValue is not greater than or equal to Threshold A (which is currently set at its secondary value), then the Threshold C is reset to its primary value in step 142, and the routine proceeds to evaluate the conditions for a digit having a lower order of magnitude.

In particular, in step 150, a determination is made as to whether the DispTimer is greater than or equal to the minimum update delay for the first digit (i.e., 1s digit). If the determination in step 150 is “Yes”, then it is determined in step 152 whether the DiffValue is greater than zero. Alternatively, if the implementation involves values with magnitudes that are smaller than 1, it is self-evident that the present invention could be modified such that one or more thresholds (e.g., 1 and 0.5) could be assigned to the 1s digits. An additional step would be needed on both results of step 152, namely, a step that resets the threshold assigned to the 1st digit to its primary value would be needed for the “No” result and a step that assigns a secondary value to the threshold for the “Yes” result. Step 154 would also have to be modified so as to reset all but the Threshold for the first digit and steps 122, 134 and 146 would need to include that the Threshold for the first digit be reset also. Such steps were not included in FIG. 1 for simplification purposes.

For the implementation shown in FIG. 1, if the determination in step 152 is “Yes”, then all thresholds (i.e., Thresholds A, B and C) are reset to their primary values, and the digital display screen is updated in step 156 by replacing the previously displayed value with the StoredValue. After displaying the updated value on the display screen, the routine proceeds back to step 106. On the other hand, if the determination in step 152 is “No”, or if the determination in step 150 is “No”, then the routine proceeds back to step 108 as shown in FIG. 1 and purposely avoids resetting the display timer.

In the present embodiment, if the input value stabilizes, eventually the minimum update delay for any and all the digits will be met, and as a consequence, the value displayed will eventually exactly match the input value. If the input value should become dynamic after the stabilization of the input value, an update of the value shown on the display will occur immediately because the minimum update delay will have been met for all of the thresholds. In contrast, in the conventional approach, the display screen would not be updated in such a scenario until the next predetermined “update time”.

As described above, after the display has been updated, the timer is reset to start a new timeframe for the next update, but only if the display was updated to a different value from the one on the display. Thus, each branch shown in FIG. 1 functions in a similar manner, with the main difference being the digit position that is affected, the difference in the predetermined minimum update delay for each digit, and the set points (i.e., primary and secondary) for the threshold values.

In the preset embodiment, by individually setting the minimum update delays for each of the digits, it is possible to decrease the amount of screen updates, and in particular, lessen screen updates that are not considered to be important to the viewer (e.g., the operator of the vehicle). For example, if a variable is changing at a rate of 100 RPM per second, it is not essential for the viewer to view how the 1s digit of the RPM value is changing. Once the update rate slows down, however, these changes may become important and a correct tuning of the minimum update delays according to the present invention will provide enhanced readability for the viewer.

Also, by utilizing the concept of the minimum update delays as explained herein, an advantage is provided over the conventional sample and hold approach which counts independent clock ticks to determine passage of time and when to update the display, disregarding the number of changes and the significance of this number in the readability of the display. In other words, in the conventional approach, it is possible to predict exactly when the display will be updated, even if an update at that moment will hinder the readability of the value currently on the display. This is because the conventional sample and hold approach includes no consideration as to the readability of the currently displayed value with respect to the previously displayed value. According to the present embodiment, however, because each digit may have a different minimum update delay, the value on the display screen is updated depending on the variation of the input value itself, and not on a fixed clock (or timer).

As a modification to the routine described above, it is noted that if the minimum update delays are guaranteed to be longer for the digits in lower orders of magnitude, then it is possible to have an algorithm that will go directly from steps 114, 126, or 138 to step 108 if the minimum update delays are not met, and start the update loop again because none of the minimum update delays of the lower order of magnitude digits would be satisfied if a higher order of magnitude digit minimum update delay is not satisfied. The embodiment shown is FIG. 1 allows all digits to have the same minimum update delay, and also allows lower order of magnitude digits to have shorter or longer display time-frames, depending on the benefits that such minimum update delays would provide for certain applications.

For example, if there is an implementation where it would be beneficial for the lower digits to have shorter minimum update delays, then it would be preferable to modify steps 118, 130 and 142 to reset all the thresholds to their primary values. Such an implementation would also be valid for any other settings of the minimum update delays, however, it was considered that for purposes of clarity, steps 118, 130 and 142 should indicate their primary purpose and hence only the resetting of the relevant Threshold was indicated. Likewise, steps 120 and 122, steps 132 and 134 as well as steps 144 and 146 could be reversed, in which case steps 122, 134 and 146 could simply reset all thresholds to their primary values followed then by an assignment of the secondary value to the relevant threshold.

Also, as a modification to the routine described above, it is noted that if the thresholds have only one primary value and no secondary value, then steps 120, 122, 118, 132, 134, 130, 144, 146, 142 and 154 could be bypassed.

Another modification of the routine described above relates to the situation in which all minimum update delays are set to the same value, in which case it would no longer be necessary to perform steps 126, 138 and 150 independently. In such a scenario, a result of “No” in step 114 would cause the routine to proceed directly to step 108, with step 128 directly following step 118, step 140 directly following step 130, and step 152 directly following step 142.

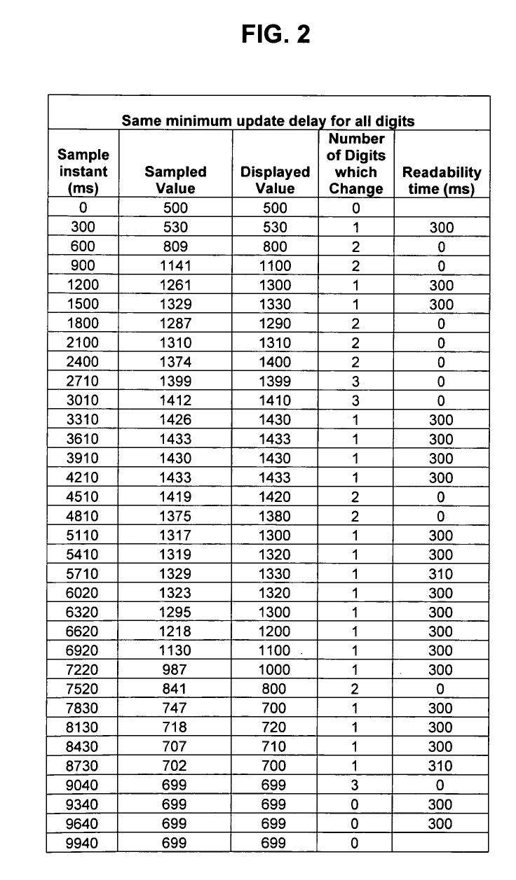

FIG. 2 is a table showing an example of digital display values according to the first embodiment using the same minimum update delay for each digit and single thresholds of 500 for the fourth digit, 50 for the third digit, and 5 for the second digit. As shown in the first column of FIG. 2, sampling is in most cases performed every 300 ms, but due to the nature of the invention, two samples occurred at 310 ms intervals. The second column of FIG. 2 represents the input value at the sampling instant. The third column represents the value displayed on the digital display, the fourth column shows the number of digits of the displayed value which change between successive samplings, and the fifth column shows the length of each sampling interval for which readability was achieved (a zero indicates that too many digits changed for the time allowed to view the value).

In this example, it is considered that 300 ms is the minimum amount of time required for a viewer to perceive an individual change in a digit and that 600 ms is required for a viewer to perceive two simultaneous changes.

As is evident from the fifth column of FIG. 2, this implementation of the invention offered a total of 6320 ms during which a number that was readable was displayed on the screen (i.e., the sum of all of the viewable time in the fifth column). It is noted that the fifth column purposely does not include the first and last samples as there are no prior or following samples respectively to compare the readability to, and as such, the 6320 ms should be compared to the total time the screen was updated excluding those samples, which is equal to 9640 ms, when determining the readability of the display. Taking the above into account, it is evident that the readability of the display was 65.56%.

Also, the goal of only 1 change (or less) per update is achieved in 65.63% of the updates. In this respect, it is noted that while the bottom three values of the table show zero changes, the algorithm shown in FIG. 1 will not update the screen if the value has not changed. These three values have been added for ease of comparison with other methods, and in particular, the conventional sample and hold method that would in fact update the screen in such instances.

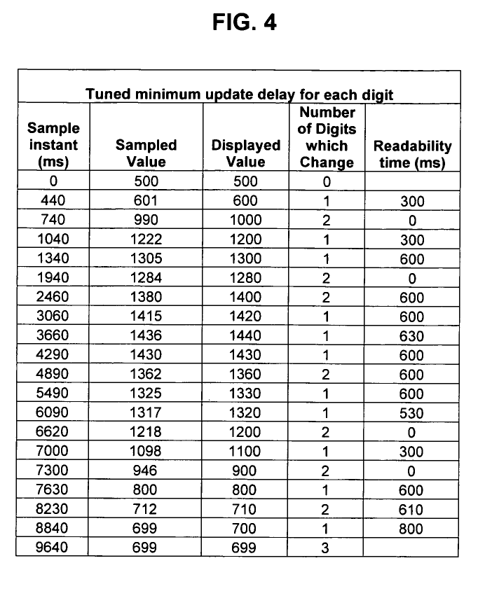

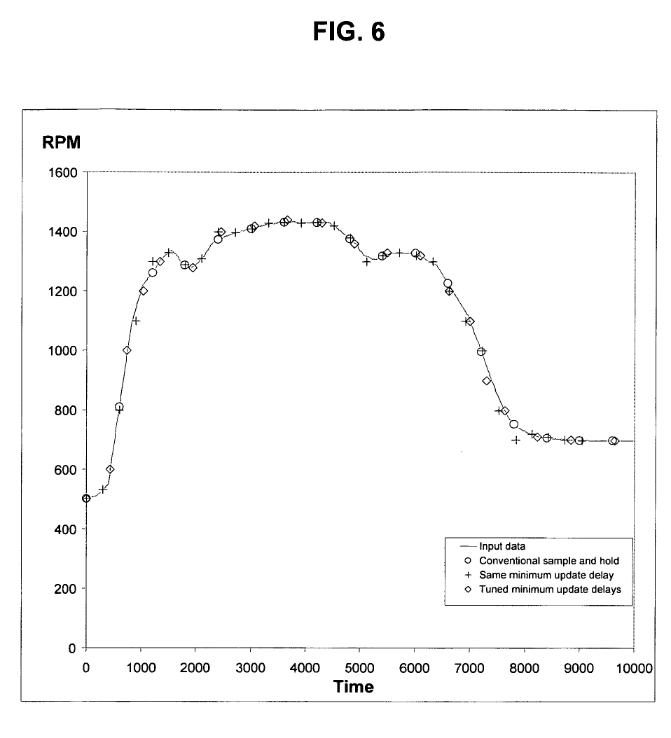

It is noted that the values shown in FIG. 2 represent sharp variations of RPM as shown in FIG. 6, where the value increases in less than 2 seconds from about 500 RPM to over 1300 RPM, then oscillates and then quickly decreases. Under such conditions, a readability of 65.63% is quite high, and it should be understood that the readability would be much higher under normal operating conditions where the RPM fluctuations would occur less abruptly. Such stressful conditions were chosen in order to highlight the advantages of one method over another. This will become more apparent when discussing FIG. 4 below.

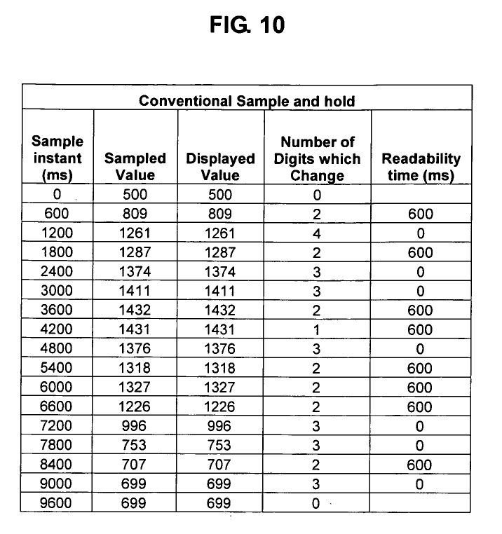

In contrast to the results shown in FIG. 2, in the sampling performed using the conventional sample and hold technique as shown in FIG. 10, only two updates occurred with only 1 digit changing, and only 53.33% of the updates would be considered readable, assuming the same minimum amount of time that is necessary to view 1 and 2 digit changes as was assumed for FIG. 2.

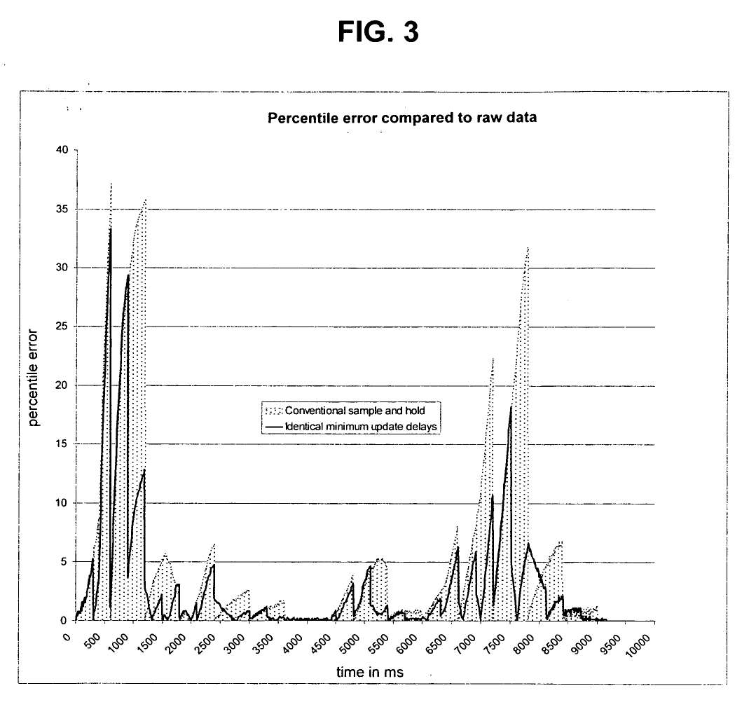

FIG. 3 is a graph showing the percentile error between the true value and the displayed value for the digital display method according to the first embodiment when utilizing the same minimum update delay for all digits (see FIG. 2) and for the conventional sample and hold digital display method (see FIG. 10). In particular, as shown in FIG. 3, the solid line represents the percentile error using the same minimum update delay for all digits, and the dotted area represents the percentile error using the conventional sample and hold digital display method.

As is evident from FIG. 3, using the first embodiment of the present invention with the same minimum update delay for all digits results in a considerable reduction in the error between the varying true value and the displayed value when compared to the traditional sample and hold technique, this reduction in error being due to the faster update rate which is allowed due to the increase in readability of each update. In addition, as is evident from FIGS. 2, 3 and 10, the present invention provides not only a significant increase in the readability of the changing numerical value being shown on the display but also offers better accuracy.

FIG. 4 is a table showing an example of digital display values according to the first embodiment using different minimum update delays for each digit and using single threshold values A=1000, B=100 and C=10. In this regard, as explained above, it is preferable that digits of less importance are set to have a longer minimum update delay than digits of greater importance. In other words, it is preferable that the digits of less importance take longer to update than the digits of greater importance. In this example, the minimum update delays were assigned as 800 ms for the 1s digit, 600 ms for the 10s digit, and 300 ms for both the 100s digit and the 1000s digit.

In FIG. 4, the first column shows the sample instant, the second column shows the value of the input value at the instant of screen update, the third column shows the value displayed on the digital display, the fourth column shows the number of digits which change in value between successive samplings, and the fifth column shows the number of milliseconds of readability time.

As is evident from the fourth and fifth columns of FIG. 4, for the first embodiment of the present invention utilizing different minimum update delays for each digit, although it results in a single digit change in only 61.11% of the actual samplings, the actual readability increases to 83.37%, assuming the same minimum amount of time that is necessary to view 1 and 2 digit changes as was assumed for FIG. 2 and FIG. 10. Thus, by providing tuned minimum update delay for each digit, readability can be greatly increased to a point where it becomes equivalent to an analog display.

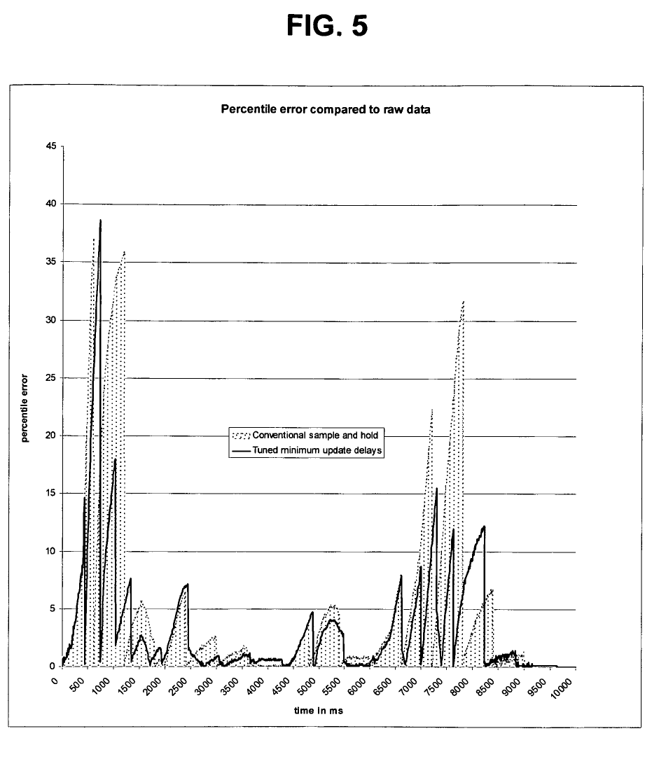

FIG. 5 is a graph showing the percentile error between the true value and the displayed value for the digital display method according to the first embodiment when utilizing a different, or tuned, minimum update delay for each of the digits (see FIG. 4) and for the conventional sample and hold digital display method (see FIG. 10). In particular, as shown in FIG. 5, the solid line represents the percentile error using tuned minimum update delays, and the dotted area represents the percentile error using the conventional sample and hold digital display method.

As is evident from FIG. 5, using the first embodiment of the present invention with a tuned (i.e., customized) minimum update delay for each digit also results in a reduction in error between the true value and the displayed value, and as described above, also provides a significant increase in the readability of the changing numerical value being shown on the display.

FIG. 6 is a graph showing a comparison between digital display values according to the first embodiment using the same minimum update delay for all of the digits (FIG. 2), digital display values according to the first embodiment using tuned minimum update delays for the digits (FIG. 4), and digital display values according to a conventional sample and hold technique (FIG. 10).

As is evident from FIG. 6, as well as the above-description, the first embodiment using either the same minimum update delay for all digits, or a tuned minimum update delay for each digit, provides display values which follow the curve of the input value very closely, and due to the reduction in the number of changes between each display value, more samples can be taken in the same period of time and hence offer better accuracy as well as readability when compared to the conventional sample and hold technique.

Also, by comparing FIGS. 4 and 10, it can be seen that both charts contain a similar amount of updates to the display screen, with FIG. 10 having 15 updates (not including the first and last) and FIG. 4 having 18 updates (also not including first and last). Although there is only a 3 update difference (less than 17% difference), the readability attained from the exact same input data increases from 53.33% in FIG. 10 to 83.37% in FIG. 4, a relative increase of over 50%, thereby demonstrating the advantages provided by the present invention.

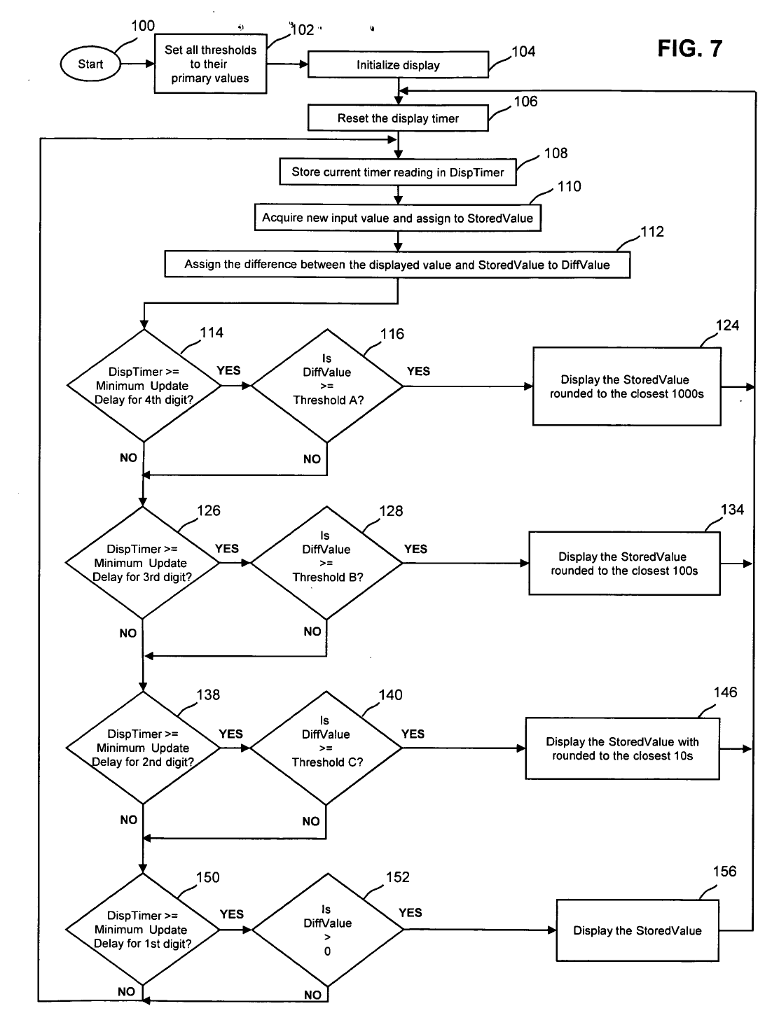

FIG. 7 shows a second embodiment of the present invention. Elements shown with the same reference numbers as the first embodiment perform the same functions as the elements in the first embodiment.

The main difference between the second embodiment and the first embodiment is that the second embodiment utilizes a single, fixed threshold for each of the digit positions, as opposed to multiple thresholds (i.e., primary threshold and secondary threshold) for each digit position as described above in connection with the first embodiment. In the second embodiment, the thresholds can be set such that (1) each threshold has a different value, (2) multiple thresholds have the same value, or (3) all of the thresholds have the same value.

As is evident from FIG. 7, the flowchart for this embodiment is the same as that for the first embodiment (i.e., FIG. 1), except that the steps related to the threshold values having primary and secondary values are omitted. Accordingly, in step 116, for example, if it is determined that the DiffValue is greater than or equal to Threshold A, then the routine proceeds directly to step 124, at which time the StoredValue is rounded to the closest 1000s, with the rounded value being output to the display. If, on the other hand, it is determined in step 116 that the DiffValue is not greater than or equal to Threshold A, then the routine proceeds directly to step 126 in which it is determined whether the DispTimer is greater than or equal to the minimum update delay set forth the third digit.

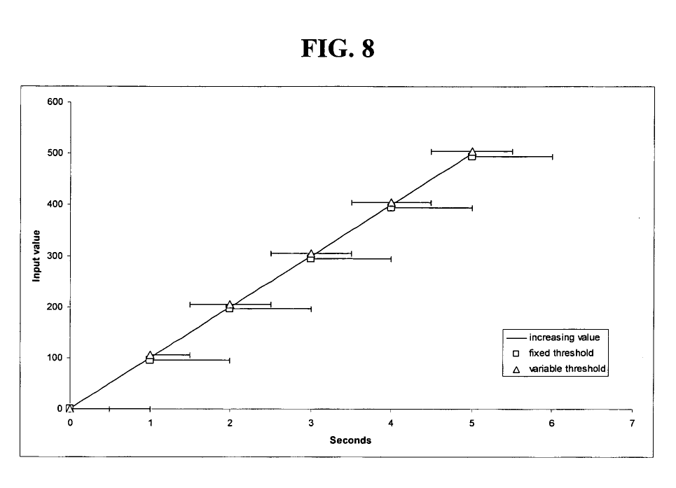

FIG. 8 is a graph representing the values that would be displayed by using identical primary and secondary thresholds or a single fixed threshold (i.e., the primary and secondary thresholds being the same or there being no secondary threshold), and variable thresholds (i.e., the primary and secondary thresholds being different).

In FIG. 8, it is assumed that the primary thresholds are 10 for the second digit (i.e., 10s digit), 100 for the third digit (i.e., 100s digit) and 1000 for the fourth digit (i.e., 1000s digit), that the corresponding secondary thresholds are 5, 50 and 500, and that the minimum update delays are set at 2 seconds for the 1s digit and the 10s digit, and set at 0.5 seconds for the 100s digit and the 1000s digit. The thresholds used in this example are typical of two approaches to rounding a number; as an example for the third digit position, when a value must be rounded to the closest 100s a threshold of 50 is typical, however, when it is desirable that a value remains unchanged until it has reached the “next” multiple of 100, then a threshold of 100 is used. Having the value displayed remain static unless a large change occurs reduces the number of changes or “flickering” as the value fluctuates, but also reduces the accuracy of the value displayed when constant change in one direction occurs. The ability to have multiple thresholds offers both static stability against flickering and accuracy when following a constantly changing value.

It is a particular feature of this invention that the center point from which the thresholds are taken is the value currently being displayed. By operating in this manner, it is possible to significantly increase the stability and accuracy of the value being displayed. For example, when a variable fluctuates between two values such as 1499 and 1500, and rounding is being performed to the closest 1000s, the conventional method will constantly show two alternating values, namely 1000 (as 1499 is rounded downwards) and 2000 (as 1500 is rounded upwards). The present invention completely eliminates this flickering because the center point of the threshold is the currently displayed value; hence even when the test digit is in the 1000s, if 1499 is displayed and 1500 follows, the difference is only 1, which is much less than the typical threshold for the 1000s. The display will show 1499 and the value would not be rounded up to 2000. However, if enough time passes, the update delay for the 1s digit will be reached, and when that happens the value will eventually be updated to 1500. Likewise, if 1500 is displayed, and the minimum update delay for the 1s digit is reached, the display will eventually show 1499. As a consequence, the present invention will effectively show that the variable is changing between these two values (and not between 1000 and 2000 like the conventional method) and will also show these changes in a very readable manner.

Using the above-noted sample values for thresholds and update delays, according to the graph shown in FIG. 8, when the sampling at 1 second is taken, the initial threshold of 100 for the third digit will have been met, and thus the variable threshold method will change the threshold for the third digit (i.e., Threshold B) to 50 (see step 132 of FIG. 1), while the fixed threshold method will maintain the threshold at 100.

Therefore, as the input value continues to increase, the new threshold will trigger an update at 1.5 seconds only for the variable threshold method because, although at that instant the minimum update delay will have been satisfied for both methods, the threshold for the fixed threshold method has still not been met (the difference between the displayed value, which is 100 at that instant, and the input value is just 50 while the fixed threshold method's threshold is at 100). At 2.0 seconds, both methods will satisfy the time requirement of 0.5 seconds for the minimum update delay for the third digit position, however, the threshold requirement will only be met for the fixed threshold method. This is because for the variable threshold method a value of 200 has been on the display since the last update at 1.5 seconds, and the difference between the displayed value and the value at 2.0 seconds, which is also 200, is zero. Only the fixed threshold method causes an update to the screen.

The result of this is that for the variable threshold method, the value 200 will be shown on the display from input values of 150 to 250, whereas if the threshold is fixed at 100, the value of 200 will be shown on the display from input values 200 to 300.

In FIG. 8, the horizontal lines represent the time the value is shown on the display (it is noted that these lines have been slightly shifted in order to offer readability of the graph, but they should be assumed to vertically overlap). With the variable threshold approach, the displayed value is more “centered” on the real value and is hence more precise. The variable threshold method is, however, based on the assumption that the input value will continue to increase as initially detected. If the input value in FIG. 8 were to suddenly flatten at a value of 260, for example, then the variable threshold method would momentarily display a value of 300 because the threshold of 50 would be met. The displayed value would then go back down to 260 when the minimum update delay for the second digit (which in this example is 2 seconds) is met. This type of a temporary overshoot (i.e., displaying a value of 300 when the input value is 260) might not be desirable in some instances, but for values that will typically not experiment sudden changes, like a vehicle's RPM, this approach might be desirable. The overshoot can also be greatly reduced if the second threshold is chosen much closer to the primary threshold, for example 100 for the primary and 80 for the secondary when referring to the values for the third digit (100s).

An example of a similar overshoot can be seen in FIG. 6 for which, although only one threshold was used for each digit, the thresholds were set at the mid-point of the digit magnitude (i.e., at 500 for the 1000s digit, at 50 for the 100s digits and at 5 for the 10s digits). FIG. 6 shows how every time the tendency of the graph changes, there is either an overshoot or an undershoot for the first embodiment of the invention with the same update delay for all digits (cross marks), but even with this overshoot/undershoot, the resulting display is greatly more accurate than the conventional sample and hold technique. For display of values that cannot suddenly experience a change in their “tendency” (e.g., rate of change of the input value), the variable threshold approach provides enhanced accuracy and readability, especially when used in conjunction with a properly tuned minimum update delay for each digit.

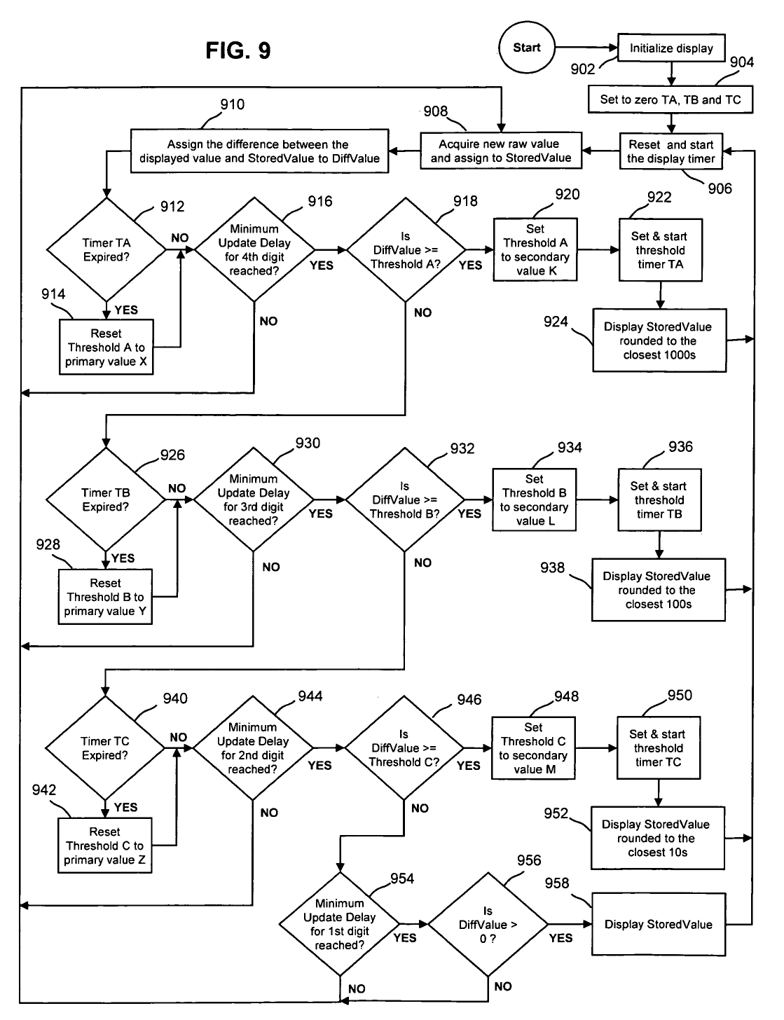

FIG. 9 shows a third embodiment of the present invention. The main difference between the third embodiment and the first embodiment is that the third embodiment introduces the use of independent magnitude threshold timers which are provided for the threshold values (e.g., Thresholds A, B and C).

In the first embodiment, the minimum update delay for each digit is used both as a delay to hold a particular digit position unaltered for a minimum amount of time as well as a measurement of time used to determine when the threshold will switch from the primary value to the secondary or vice versa. In the third embodiment, the delay to hold a particular digit position unaltered for a minimum amount of time can be unrelated to the measurement of time used to determine when the value of the threshold will change, and these may thus be completely asynchronous.

As shown in the flowchart of FIG. 9, in step 902, the display is initialized to a value. While this value can be arbitrarily set by a user, the display will typically be initialized to the first sampling of an input value or to zero. In step 904 of FIG. 9, threshold timers TA, TB and TC are set to zero, and in step 906, the display timer is reset and started. As explained previously, the display timer is used to measure the amount of time that the current value on the display has been displayed on the display.

In step 908 of FIG. 9, an input value is acquired and this value is assigned as StoredValue. In step 910, the absolute difference between the value currently being displayed and the StoredValue is assigned as the DiffValue. If this is the first run of the algorithm, and the display was initialized with the initial input value, then DiffValue will be zero at this point.

As shown in FIG. 9, in step 912, it is determined whether threshold timer TA has expired. Threshold timer TA is preferably a countdown timer, and therefore, the threshold timer TA is considered expired when it reaches zero, wherein the timer will automatically stop upon reaching zero. Since the threshold timer TA was set to zero in step 904, the initial run of the algorithm will result in a positive determination at step 912, and therefore, the flow will continue to step 914 where the Threshold A is set to the primary value X.

In step 916 it is determined whether the minimum update delay for the fourth digit has been reached. A negative determination at step 916 will result in the algorithm returning to step 908, where a new input value is acquired. The display timer is not stopped or reset, and hence its value will continue to increase. As is evident from FIG. 9, during the time that the minimum update delay has not been reached for the fourth digit, the algorithm will cycle between steps 908, 910, 912, 914 and 916. Once the display timer has reached the minimum update delay for the fourth digit, however, step 918 will follow step 916.

A negative determination in step 918 will result in a flow to step 926, where it is examined if the threshold timer TB has expired. Similar to the discussion above regarding threshold timer TA, since in step 904 the threshold timer TB was set to zero, the first time step 926 is reached, step 928 will follow and the Threshold B will be set to its primary value Y. In step 930, it is determined whether the minimum update delay for the third digit has been reached. A negative determination in step 930 will result in the algorithm cycling through steps 908, 910, 912, 914, 916, 918, 926, 928 and 930 for as long as the determination in steps 918 and 930 are negative.

On the other hand, a positive determination in step 918 will divert the flow to step 920, where the Threshold A is set to a secondary value K. Next, the threshold timer TA is set to a predefined value, which is the length of time that Threshold A must remain at the secondary value, and this timer is then started. After setting and starting the threshold timer TA, in step 924, the display is updated so as to display the StoredValue rounded to the closest 1000s. Step 906 then resets the display timer, which begins a new measurement of the time that the current value has been on the display, and steps 908 and 910 assign new values to StoredValue and to DiffValue.

The first time the algorithm reaches step 912 after having updated the display, the threshold timer TA will not have expired (unless threshold timer TA is set to a very small value in step 922) and thus Threshold A will remain at the secondary value. In addition, in step 916, a negative determination will result because the timer was just reset in step 906, as described above. The loop then follows steps 908, 910, 912 and 916 until the minimum update delay has been reached. As is evident from FIG. 9, when step 916 results in a positive determination, step 918 compares DiffValue to the secondary Value of Threshold A. Typically the secondary value is set lower than the primary value, and therefore, the secondary value is more likely to trigger a positive determination at step 918. A positive determination in step 918 will follow the same path described above. It is to be noted that in step 922, the threshold timer TA is reset and hence, as long as step 918 results in a positive determination before TA expires, the threshold timer TA will continue to cause a negative determination in step 912. If, however, step 918 results in a negative determination, the threshold timer TA will continue to count down until it times-out or expires, which will result in a positive determination in step 912, which will in turn cause Threshold value A to return to its primary value in step 914.

In FIG. 9, it is noted that the branch that includes steps 926, 928, 930, 932, 934, 936 and 938 functions in a similar manner to the branch that includes steps 912, 914, 916, 918, 920, 922 and 924, with the only difference being the operational variables. Likewise, the branch that includes steps 940, 942, 944, 946, 948, 950 and 952 also functions in a similar manner, while utilizing different operational variables, but as shown in FIG. 9, the step that compares the DiffValue to the Threshold C (step 946) does not follow to a step that determines whether a threshold timer has expired. This is because for the last digit position (i.e., 1s digit), it is usually not necessary to utilize a threshold. It is possible, however, that the input value (and StoredValue) contain fractional amounts, and thus it is possible, for example, to have thresholds of 0.5 or 0.3 for the lowest digit position. For simplification, it is assumed in the flowchart of FIG. 9 that whole numbers are being utilized.

As shown in FIG. 9, the branch that evaluates the first digit simply checks to see if the minimum update delay for the first digit has been reached and if StoredValue is different from the value on the display (or DiffValue>0). A negative determination in either step 954 or step 956 will result in the algorithm returning to step 908 where a new input value is obtained. Eventually, when the minimum update delay has been reached and the value of StoredValue is different from the value on the display, the display will be updated and the cycle will be restarted.

It should be noted that a computer program can be utilized for causing a display unit to perform the display method according to each of the above-described embodiments of the present invention, with the program being stored on a computer-readable medium such as a CD-ROM or other known storage medium. Alternatively, the display methods according to each of the embodiments can be implemented by electronic circuitry with or without the use of any software.

The previous description is provided to enable a person skilled in the art to make and use the present invention. Moreover, various modifications to the illustrative embodiments above will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

What is claimed is:

1. A method for updating a numerical value of a variable displayed on a display unit, for which any digit position of possible digits of the numerical value is referred to as a test digit position, wherein said method comprises:
identifying a numerical value currently displayed on the display unit;
determining an amount of time that has elapsed since the numerical value currently displayed on the display unit was displayed on the display unit;
obtaining a current numerical value of the variable; and
determining an absolute difference between the numerical value currently displayed on the display unit and the current numerical value of the variable;
wherein the test digit position is assigned a minimum update delay, the minimum update delay assigned to the test digit position being a value to be compared to the determined amount of time that has elapsed since the numerical value currently displayed on the display unit was displayed on the display unit,
wherein the test digit position is assigned a magnitude threshold value, the magnitude threshold value assigned to the test digit position being a value to be compared to the determined absolute difference between the numerical value currently displayed on the display unit and the current numerical value of the variable, and
wherein, if the determined amount of time that has elapsed since the numerical value currently displayed on the display unit was displayed on the display unit is equal to or greater than the minimum update delay assigned to the test digit position, and the determined absolute difference between the numerical value currently displayed on the display unit and the current numerical value of the variable is equal to or greater than the magnitude threshold value assigned to the test digit position, then an updated numerical value is generated that replaces the numerical value currently displayed on the display unit, the updated numerical value being based on the obtained current numerical value of the variable.

2. The method according to claim 1, wherein the method is a cyclical method that causes the numerical value currently displayed on the display unit to be repeatedly updated.

3. The method according to claim 2, wherein the minimum update delay assigned to the test digit position varies according to the order of magnitude of the test digit position.

4. The method according to claim 3, wherein the magnitude threshold value is a fixed value according to the order of magnitude of the test digit position.

5. The method according to claim 3,
wherein the magnitude threshold value of the test digit position has two fixed values, the two fixed values being a first value and a second value,
wherein a magnitude threshold reset time is designated, the designated magnitude threshold reset time being compared to a determined length of time that has elapsed since the magnitude threshold value was set to the second value, and
wherein the magnitude threshold value changes from the second value to the first value after the magnitude threshold reset time has elapsed.

6. The method according to claim 2, wherein the minimum update delay assigned to the test digit position is the same regardless of the order of magnitude of the test digit position.

7. The method according to claim 6, wherein the magnitude threshold is a fixed value according to the order of magnitude of the test digit position.

8. The method according to claim 6,
wherein the magnitude threshold value of the test digit position has two fixed values, the two fixed values being a first value and a second value,
wherein a magnitude threshold reset time is designated, the designated magnitude threshold reset time being compared to a determined length of time that has elapsed since the magnitude threshold value was set to the second value, and
wherein the magnitude threshold value changes from the second value to the first value after the magnitude threshold reset time has elapsed.

9. The method according to claim 2, wherein the minimum update delay assigned to the test digit position is the same for at least two of the possible digit positions.

10. The method according to claim 9,
wherein the magnitude threshold value has two fixed values, the two fixed values being a first value and a second value, and
wherein the magnitude threshold value switches between the first value and the second value.

11. The method according to claim 2, wherein the magnitude threshold value is a fixed value according to the order of magnitude of the test digit position.

12. The method according to claim 2,
wherein the magnitude threshold value has two fixed values, the two fixed values being a first value and a second value, and
wherein the magnitude threshold value switches between the second value and first value.

13. The method according to claim 2, wherein digits of the updated numerical value are controlled such that at least one digit position having a lower order of magnitude than the test digit position is set to zero.

14. The method according to claim 1, wherein digits of the updated numerical value are controlled such that at least one digit position having a lower order of magnitude than the test digit position is set to zero.

15. The method according to claim 2, wherein the test digit position changes during the cyclical method.

16. The method according to claim 15, wherein the minimum update delay assigned to the test digit position is dependent upon the order of magnitude of the test digit position.

17. The method according to claim 16, wherein the magnitude threshold value is a fixed value according to the order of magnitude of the test digit position.

18. The method according to claim 16,
wherein the magnitude threshold value of the test digit position has two fixed values, the two fixed values being a first value and a second value,
wherein a magnitude threshold reset time is designated, the designated magnitude threshold reset time being compared to a determined length of time that has elapsed since the magnitude threshold value was set to the second value, and
wherein the magnitude threshold value changes from the second value to the first value after the magnitude threshold reset time has elapsed.

19. The method according to claim 15, wherein the minimum update delay assigned to the test digit position is the same regardless of the order of magnitude of the test digit position.

20. The method according to claim 19, wherein the magnitude threshold is a fixed value according to the order of magnitude of the test digit position.

21. The method according to claim 1, wherein the updated numerical value is the numerical value of the variable rounded to the same order of magnitude as the test digit position.

22. The method according to claim 2, wherein the updated numerical value is the numerical value of the variable rounded to the same order of magnitude as the test digit position.
